(19) United States
(12) Patent Application Publication
(10) Pub. No.: US 2025/0391067 A1
(43) Pub. Date: Dec. 25, 2025

(54) VIRTUAL OBJECT GENERATION DEVICE

(71) Applicant: NTT DOCOMO, INC., Tokyo (JP)

(72) Inventor: Kouhei OOYAMA, Chiyoda-ku (JP)

(73) Assignee: NTT DOCOMO, INC., Tokyo (JP)

(21) Appl. No.: 18/880,073

(22) PCT Filed: Jun. 6, 2023
(86) PCT No.: PCT/JP2023/021032

§ 371 Date: Dec. 30, 2024

(30) Foreign Application Priority Data
Aug. 5, 2022 (JP) 2022-125657

(51) Int. Cl. G06T 11/20

(52) U.S. Cl. CPC G06T 11/20; G06T 2200/24

(57) ABSTRACT

An avatar generation device 10 according to one embodiment includes a generation unit 12 configured to generate an avatar usable in a plurality of services that provide a virtual space to a user; a determination unit 13 configured to determine a target service that is one of the plurality of services; a parameter acquisition unit 14 configured to acquire a drawing parameter indicating a drawing condition applied to the avatar in the target service; and a display unit 15 configured to generate and display a preview image showing the avatar corresponding to the target service by applying the drawing parameter acquired by the parameter acquisition unit 14 to the avatar generated by the generation unit 12.

### TECHNICAL FIELD

An aspect of the present invention relates to a virtual object generation device.

### BACKGROUND ART

Services that provide virtual spaces such as Virtual Reality (VR), Augmented Reality (AR), and Mixed Reality (MR) to users are known. In such services, for example, users can enjoy the virtual space by operating an avatar (virtual object) that represents themselves. There are multiple services that utilize XR (Extended Reality) such as VR, AR, and MR, and since the systems for creating avatars differ for each service, users face the issue of having to create avatars for each service individually. Non-Patent Document 1 discloses a system (Docomo Avatar Portal) that addresses this issue by generating avatars that can be commonly used across multiple services and managing the generated avatars linked to the user's account.

### CITATION LIST

### Non-Patent Document

[Non-Patent Document 1] “Development of Docomo Avatar Portal that allows customers to create and manage avatars in XR space,” Jan. 20, 2022, [online], [retrieved on Jul. 28, 2022], Internet <https://www.docomo.ne.jp/info/news_release/2022/01/11_00.html>

### SUMMARY OF INVENTION

### Technical Problem

According to the system disclosed in Non-Patent Document 1, users are freed from the hassle of generating avatars individually for each service that uses XR. However, the drawing conditions (e.g., shader, light conditions) applied when rendering virtual objects (avatars) in the virtual space may differ between the generation environment (e.g., the environment provided by the system disclosed in Non-Patent Document 1) and each service. In such cases, the appearance (visual representation) of the virtual object confirmed by the preview display function provided by the generation environment may differ from the appearance applied when the virtual object is actually used in each service. If the discrepancy in the appearance of the virtual object is significant, users may feel dissatisfied.

Therefore, one aspect of the present invention aims to provide a virtual object generation device that can improve the quality of the user's service experience by preventing the appearance of the virtual object in the service providing the virtual space from deviating from the user's intention.

### Solution to Problem

A virtual object generation device according to one aspect of the present invention includes a generation unit configured to generate a virtual object usable in a plurality of services that provide a virtual space to a user; a determination unit configured to determine a target service that is one of the plurality of services; a parameter acquisition unit configured to acquire a drawing parameter indicating a drawing condition applied to the virtual object in the target service; and a display unit configured to generate and display a preview image showing the virtual object corresponding to the target service by applying the drawing parameter acquired by the parameter acquisition unit to the virtual object generated by the generation unit.

In the virtual object generation device according to one aspect of the present invention, a function to preview the generated virtual object is provided to the user along with the generation environment for generating the virtual object. Furthermore, during the preview display, the virtual object displayed is not based on the drawing parameters prepared in advance in the generation environment but on the drawing parameters used in one of the services (target service) that provide the virtual space. According to the above configuration, the user can confirm the appearance applied when the virtual object is used in the target service at the time of the preview display (i.e., before the user actually uses the virtual object in the target service). As a result, when the user actually uses the virtual object generated in the generation environment in the target service, the appearance of the virtual object can be prevented from deviating from the user's intention, thereby improving the quality of the user's service experience.

### Advantageous Effects of Invention

According to one aspect of the present invention, it is possible to provide a virtual object generation device that can improve the quality of the user's service experience by preventing the appearance of the virtual object in the service providing the virtual space from deviating from the user's intention.

### BRIEF DESCRIPTION OF DRAWINGS

FIG. 1 is a diagram showing an example of the configuration of an information system including an avatar generation device according to one embodiment.

FIG. 2 is a diagram showing an example of the avatar generation environment provided by the avatar generation device and the generated avatar.

FIG. 3 is a diagram showing the appearance of the avatar when the avatar generated by the avatar generation device is used in one service (Service A).

FIG. 4 is a block diagram showing an example of the functional configuration of the avatar generation device.

FIG. 5 is a diagram showing an example of the preview display processing by the avatar generation device.

FIG. 6 is a diagram schematically showing two usage patterns of the avatar generation environment.

FIG. 7 is a flowchart showing an example of the operation of the avatar generation device.

FIG. 8 is a flowchart showing a first example of the processing in step S2 of FIG. 7.

FIG. 9 is a flowchart showing a second example of the processing in step S2 of FIG. 7.

FIG. 10 is a diagram showing an example of the menu screen presented to the user in step S22 of FIG. 9.

FIG. 11 is a flowchart showing a third example of the processing in step S2 of FIG. 7.

FIG. 12 is a diagram showing an example of the history information acquired in step S31 of FIG. 11.

FIG. 13 is a diagram showing an example of the hardware configuration of the avatar generation device.

### DESCRIPTION OF EMBODIMENTS

Hereinafter, embodiments of the present invention will be described in detail with reference to the accompanying drawings. In the description of the drawings, the same or equivalent elements are denoted by the same reference signs and redundant description thereof will be omitted.

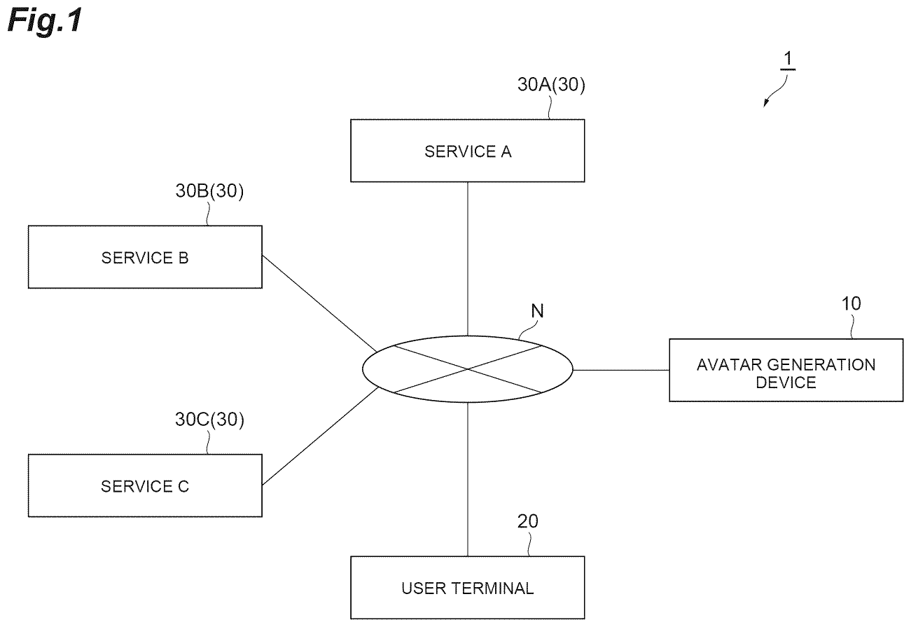

FIG. 1 is a diagram showing an example of the configuration of an information system 1 including an avatar generation device 10 (virtual object generation device) according to one embodiment. The information system 1 includes an avatar generation device 10, a user terminal 20, and a plurality of servers 30. The avatar generation device 10, the user terminal 20, and the plurality of servers 30 are connected to each other via a wired or wireless communication network N to enable data communication. Note that it is sufficient if at least the avatar generation device 10 and the user terminal 20, and the user terminal 20 and each server 30 can communicate with each other, and the avatar generation device 10 and each server 30 do not necessarily need to be configured to communicate with each other.

The avatar generation device 10 is a device that provides an avatar generation environment (object generation environment) for generating avatars to the user. An avatar is an example of a virtual object. A virtual object is an object that does not exist in the real world and is represented on a computer system. Virtual objects can be represented, for example, by 2D or 3D computer graphics (CG). However, the method of representing virtual objects is not limited. For example, virtual objects may be represented using animation materials or may be represented to look realistic based on live-action images. The details of the functions of the avatar generation device 10 will be described later.

The user terminal 20 is a computer terminal used by the user. The type of user terminal 20 is not limited. For example, the user terminal 20 may be a personal computer such as a desktop PC or a laptop PC, a terminal device such as a smartphone or a tablet held in the user's hand, or a wearable device worn on a part of the user's body such as the head. Examples of wearable devices include head-mounted displays such as goggle-type, glasses-type (spectacle-type), and hat-type.

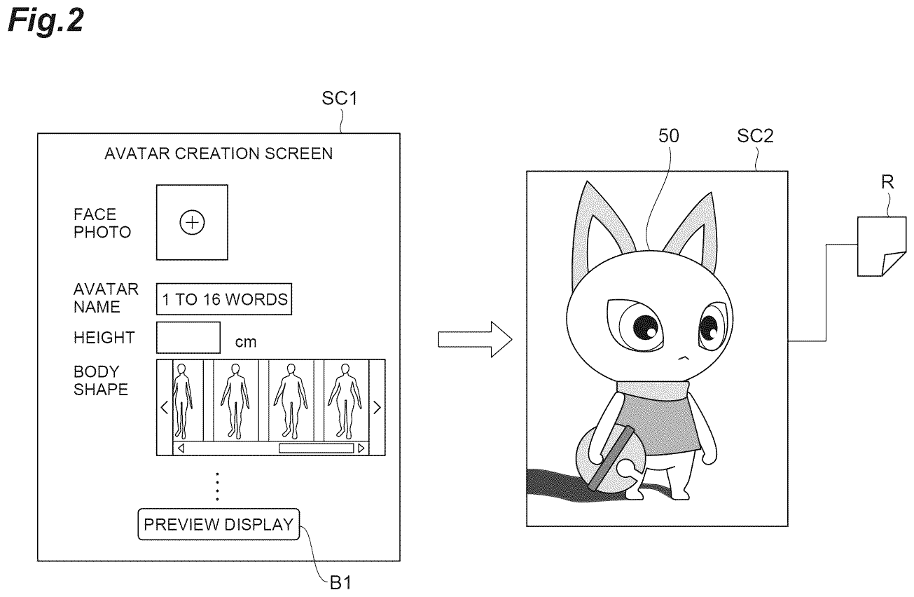

The user terminal 20 includes a display unit 20a for displaying an avatar creation screen SC1 and a preview screen SC2 (see FIG. 2) provided by the avatar generation device 10, and a service screen (virtual space image including an avatar) provided by each server 30. When the user terminal 20 is a PC, the display unit 20a may be configured by a display monitor. When the user terminal 20 is a mobile terminal such as a smartphone, the display unit 20a may be configured by a touch panel display. When the user terminal 20 is a head-mounted display, the display unit 20a may be configured by a display arranged in front of both eyes of the user.

The user terminal 20 includes an operation interface for receiving input operations from the user. When the user terminal 20 is a PC, the operation interface is an input device such as a mouse or a keyboard. When the user terminal 20 is a mobile terminal such as a smartphone, the touch panel display functions as the display unit 20a described above and also functions as the operation interface. When the user terminal 20 is a head-mounted display, a dedicated controller held in the user's hand may be used as the operation interface. However, the above is an example, and the user terminal 20 may include an operation interface other than the above (e.g., a voice input device).

The server 30 is a device that provides a virtual space to the user. More specifically, the server 30 provides an avatar utilization service (service) that displays the avatar generated in the avatar generation environment in the virtual space. The virtual space provided by the server 30 may be a Virtual Reality (VR) space, an Augmented Reality (AR) space, or a Mixed Reality (MR) space. That is, the avatar utilization service is an XR (Extended Reality) service that allows the use of avatars in VR, AR, MR, etc. In FIG. 1, as examples of the plurality of servers 30, a server 30A providing Service A, a server 30B providing Service B, and a server 30C providing Service C are illustrated, but the plurality of servers 30 may include one or more other servers providing avatar utilization services other than Services A, B, and C.

FIG. 2 is a diagram showing an example of the avatar generation environment provided by the avatar generation device 10 and the generated avatar 50. As shown in FIG. 2, in this embodiment, the avatar generation device 10 provides an avatar generation environment for determining (editing) the appearance of the avatar based on the user's operations. As an example, the avatar generation device 10 displays the avatar creation screen SC1 on the user terminal 20, receives user operations (user inputs) on the avatar creation screen SC1, and generates the avatar based on the received user operations. The user can input various information for determining the appearance of the avatar through the avatar creation screen SC1. In the example of FIG. 2, the user can upload their own face photo, input the avatar name, and input its height and body shape. Note that these pieces of input information are examples, and the avatar creation screen SC1 may be configured to accept input information other than the above examples.

The user can open the preview screen SC2 to confirm the appearance of the avatar generated based on the information input by the user as described above by performing an operation to select the link button B1 for performing the preview display arranged on the avatar creation screen SC1. The appearance of the generated avatar 50 is displayed on the preview screen SC2. Here, when displaying (rendering) the avatar in the virtual space, predetermined drawing conditions (rendering conditions) are applied to the avatar. The drawing conditions include various drawing parameters used to represent the appearance of the avatar in the virtual space, such as shader conditions (e.g., shadowing) and light conditions (e.g., light reflection). In the example of FIG. 2, the drawing parameters R indicating the drawing conditions predetermined in the avatar generation environment are applied to the avatar 50 displayed on the preview screen SC2. In this example, the drawing parameters R include parameters indicating the shader condition “apply Unlit shader (shader not affected by light)” and the light condition “with light.”

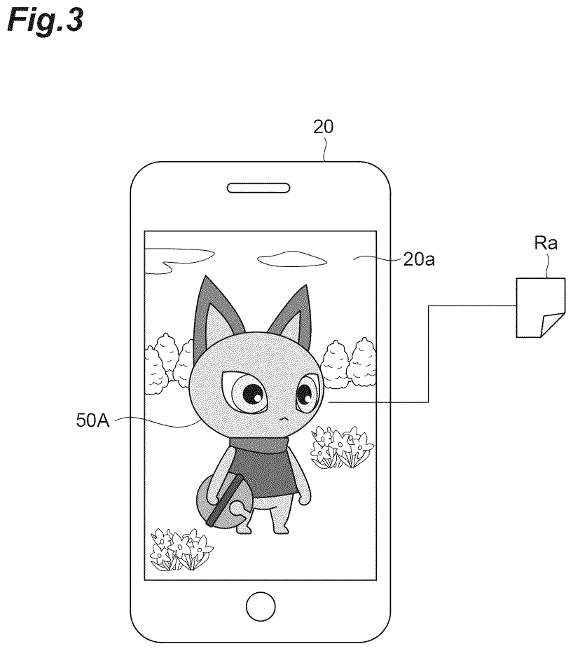

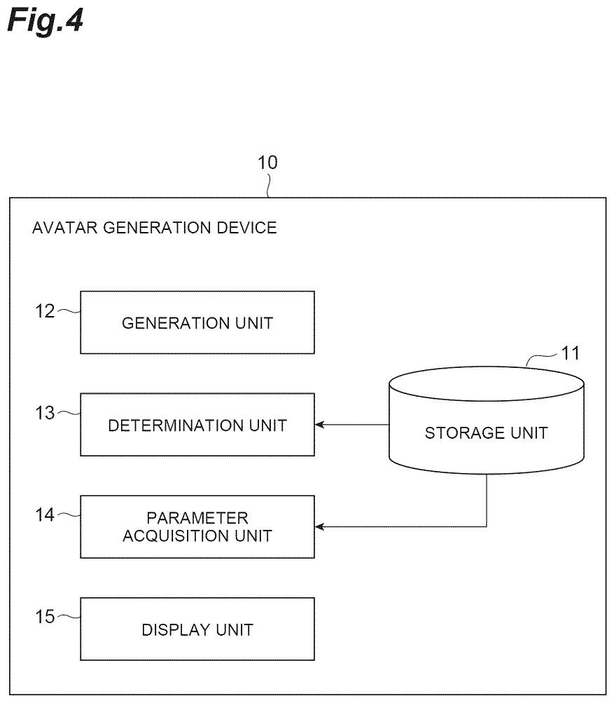

FIG. 3 is a diagram showing the appearance of the avatar 50A when the avatar 50 generated by the avatar generation device 10 (avatar generation environment) is used in one service (here, as an example, Service A provided by the server 30A). As shown in FIG. 3, when the user uses Service A, a virtual space image including the avatar 50A rendered by Service A is displayed on the display unit 20a of the user terminal 20. The drawing parameters Ra indicating the drawing conditions predetermined in Service A are applied to the avatar 50A. The drawing parameters Ra may differ from the drawing parameters R predetermined in the avatar generation environment described above. In this embodiment, the drawing parameters Ra include parameters indicating the shader condition “apply monochrome shader” and the light condition “no light.” Thus, when the drawing parameters R prepared in the avatar generation environment differ from the drawing parameters Ra prepared in Service A, the appearance of the avatar 50 confirmed on the preview screen SC2 in the avatar generation environment (see FIG. 2) may deviate from the appearance of the avatar 50A when actually used in Service A (see FIG. 3), potentially causing user dissatisfaction. Especially if the user has spent considerable time and effort creating the avatar in the avatar generation environment, the user's dissatisfaction due to the discrepancy in appearance may be significant. Therefore, the avatar generation device 10 has functions to avoid such user dissatisfaction. The functions of the avatar generation device 10 will be described below with reference to FIG. 4.

FIG. 4 is a block diagram showing an example of the functional configuration of the avatar generation device 10. As shown in FIG. 4, the avatar generation device 10 includes a storage unit 11 (parameter storage unit, list information storage unit, history information storage unit), a generation unit 12, a determination unit 13, a parameter acquisition unit 14, and a display unit 15.

The storage unit 11 stores various data used in the avatar generation device 10. As an example, the storage unit 11 stores the drawing parameters corresponding to each of the plurality of avatar utilization services (in this embodiment, Services A, B, C, etc. in FIG. 1) in association with each of the plurality of services. That is, the storage unit 11 holds in advance the drawing parameters Ra corresponding to Service A described above, as well as the drawing parameters Rb and Rc corresponding to other Services B and C.

The storage unit 11 also stores list information indicating a list of services usable by the user among the plurality of services. In this embodiment, as an example, the user of the user terminal 20 has completed the usage registration (account registration) for Services A, B, and C and can use Services A, B, and C. In this case, the list information stores Services A, B, and C as a list of services usable by the user.

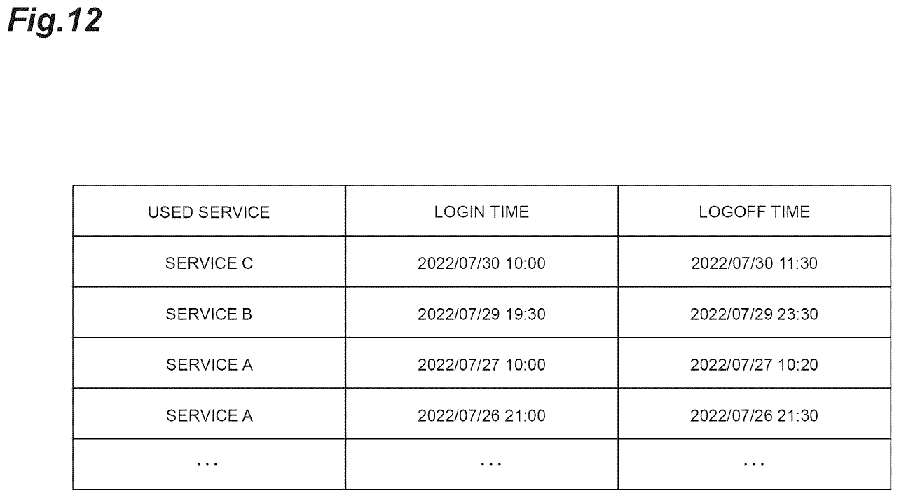

The storage unit 11 also stores history information (see FIG. 12) regarding the user's usage history for the plurality of services. As an example, the history information is information that accumulates the used services and information regarding the usage period of each service (e.g., login time and logoff time). By referring to the history information, it is possible to identify the service most recently used by the user, the service with the highest number of uses in a recent predetermined period, the service used for the longest time in a recent predetermined period, etc.

Note that when there are multiple users who can use the avatar generation environment provided by the avatar generation device 10 (i.e., when the avatar generation device 10 is configured to provide the avatar generation environment to multiple users), the storage unit 11 may store the list information and history information described above for each user (user account).

The generation unit 12 generates avatar usable in a plurality of services (e.g., Services A, B, C, etc. in FIG. 1) that provide a virtual space to the user. In this embodiment, the generation unit 12 provides the avatar generation environment (see FIG. 2) for determining the appearance of the avatar based on the user's operations. As an example, the generation unit 12 allows the user to use the avatar generation environment in response to receiving a usage request for the avatar generation environment from the user (user terminal 20). That is, the generation unit 12 displays the avatar creation screen SC1 on the display unit 20a of the user terminal 20 in response to receiving the usage request from the user and receives operations from the user to input information for determining the appearance of the avatar. The generation unit 12 then determines the appearance of the avatar based on the information input by the user.

The determination unit 13 determines a target service that is one of the plurality of services. The details of the processing of the determination unit 13 will be described later in conjunction with the description of the processing flow.

The parameter acquisition unit 14 acquires the drawing parameters indicating the drawing conditions applied to the avatar in the target service determined by the determination unit 13. As an example, the parameter acquisition unit 14 acquires the drawing parameters corresponding to the target service from the storage unit 11 by referring to the storage unit 11 using the target service as key information. For example, when “Service A” is determined as the target service by the determination unit 13, the parameter acquisition unit 14 acquires the drawing parameters Ra corresponding to Service A from the storage unit 11 by referring to the storage unit 11 using “Service A” as key information.

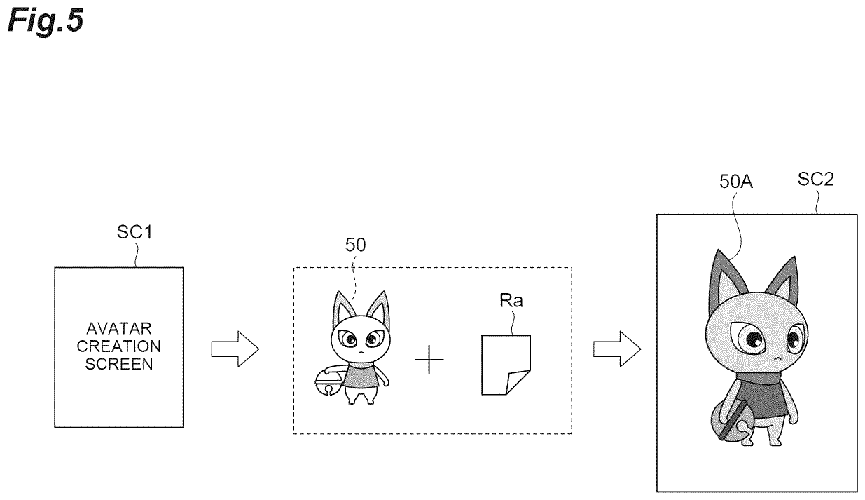

The display unit 15 generates a preview image showing the avatar generated by the generation unit 12 (i.e., the image of the avatar displayed on the preview screen SC2). FIG. 5 is a diagram showing an example of the preview display processing by the display unit 15. As shown in FIG. 5, the display unit 15 applies the drawing parameters acquired by the parameter acquisition unit 14 to the avatar 50 generated by the generation unit 12 (avatar creation screen SC1) (i.e., the avatar having the appearance with the drawing parameters R predetermined in the avatar generation environment). Here, as an example, the display unit 15 applies the drawing parameters Ra corresponding to Service A determined as the target service to the avatar 50, thereby generating and displaying a preview image showing the avatar 50A corresponding to the target service (i.e., the avatar having the appearance with the drawing parameters Ra). According to the above preview display processing, the user can confirm the appearance of the avatar applied when the avatar is actually used in the target service when confirming the appearance of the avatar generated in the avatar generation environment.

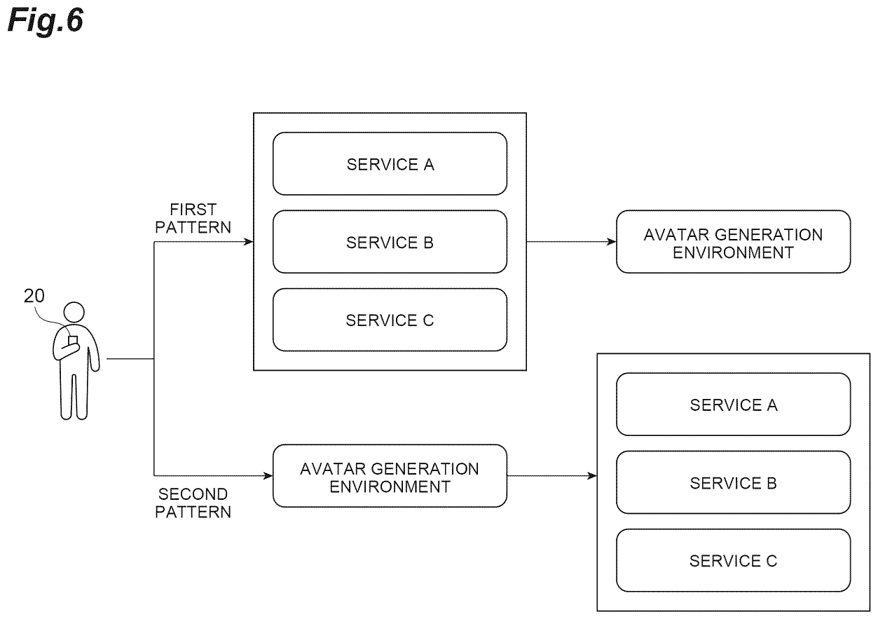

FIG. 6 is a diagram schematically showing two usage patterns of the avatar generation environment provided by the avatar generation device 10.

The first pattern is a pattern in which the user accesses the avatar generation environment while using an avatar utilization service (one of Services A, B, C). For example, the first pattern corresponds to a case where the user wants to change the appearance of the avatar while using the avatar utilization service and accesses the avatar generation environment. For example, a link button labeled “Create (Edit) Avatar” may be displayed in the virtual space provided by the avatar utilization service. In this case, the user can execute an operation to select the link button, thereby sending a usage request for the avatar generation environment to the avatar generation device 10 and transitioning to the avatar generation environment.

The second pattern is a pattern in which the user accesses the avatar generation environment before using the avatar utilization service (i.e., in a state where the avatar utilization service is not being used). That is, the second pattern corresponds to a case where the user prepares the avatar in advance, assuming that the avatar will be used in one of the avatar utilization services.

The mechanism of the avatar generation device 10 described above can be used in both the first pattern and the second pattern. The operation of the avatar generation device 10 in each pattern will be described later in conjunction with the description of the processing flow.

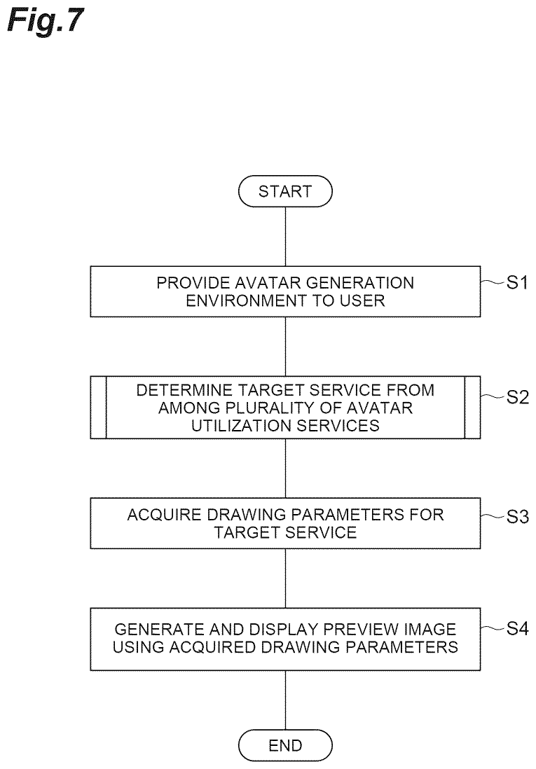

FIG. 7 is a flowchart showing an example of the operation of the avatar generation device 10. In step S1, the generation unit 12 provides the avatar generation environment (see FIG. 2) to the user. For example, the generation unit 12 provides the avatar generation environment to the user in response to receiving a usage request for the avatar generation environment from the user (user terminal 20). Here, in the case of the first pattern described above, the generation unit 12 acquires service information indicating the avatar utilization service used by the user before accessing the avatar generation environment (i.e., the avatar utilization service from which the transition was made). For example, if the avatar utilization service used by the user is “Service A,” the service information is information for identifying Service A. The service information may be any information that can uniquely identify Service A, and is not limited to a specific form of information. Examples of service information include the service name and information indicating the access destination (e.g., URI) of Service A.

In step S2, the determination unit 13 determines the target service from among the plurality of avatar utilization services. Examples of the processing in step S2 (first example to third example) will be described below.

### First Example

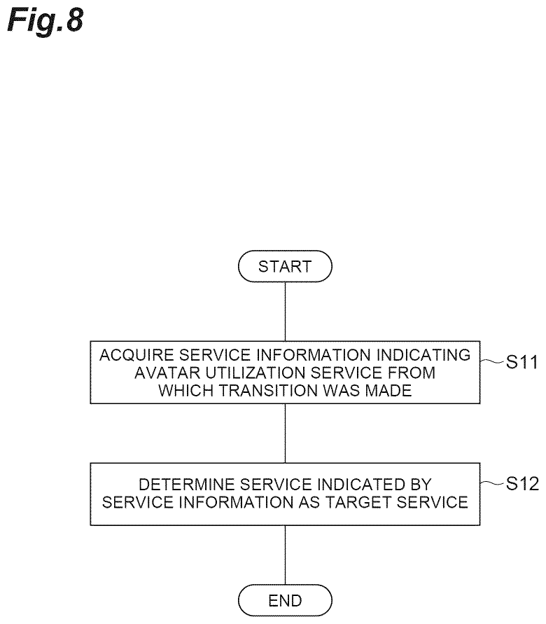

FIG. 8 is a flowchart showing a first example of the processing in step S2. The first example corresponds to the first pattern described above. That is, the first example corresponds to a case where the avatar generation environment transitions from a first state in which one of the plurality of avatar utilization services is used by the user to a second state in which the avatar generation environment is used by the user. In the first example, the determination unit 13 acquires service information indicating the one service used by the user in the first state and determines the one service indicated by the service information as the target service. An example of the operation related to the above processing will be described below.

In step S11, the determination unit 13 acquires service information indicating the avatar utilization service from which the transition was made (i.e., the one service used by the user in the first state). Here, as an example, it is assumed that the user accessed the avatar generation environment while using Service A. In this case, in this embodiment, the service information indicating Service A is acquired in step S1. Therefore, the determination unit 13 may acquire the service information acquired by the generation unit 12 in step S1.

In step S12, the determination unit 13 determines the one service (here, “Service A”) indicated by the service information acquired in step S11 as the target service.

### Second Example

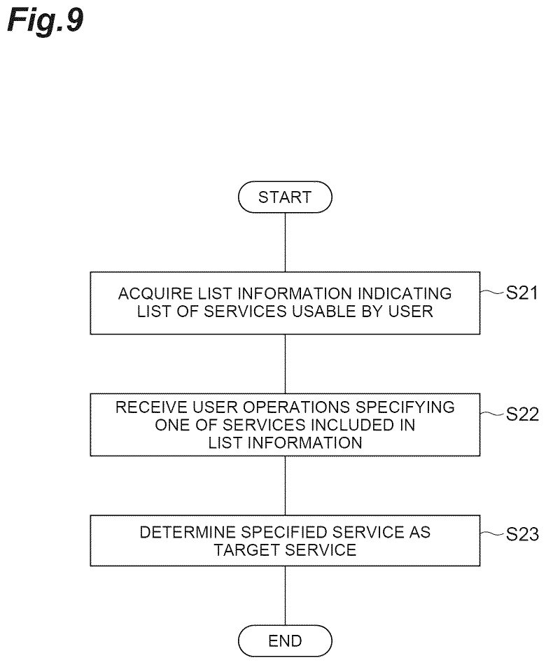

FIG. 9 is a flowchart showing a second example of the processing in step S2. The second example corresponds to the second pattern described above. In the second example, the determination unit 13 allows the user to specify one of the services included in the list information stored in the storage unit 11 and determines the one service specified by the user as the target service. An example of the operation related to the above processing will be described below.

In step S21, the determination unit 13 acquires the list information indicating the list of services usable by the user. In this embodiment, the determination unit 13 acquires the list information corresponding to the user of the user terminal 20 that accessed the avatar generation environment by referring to the storage unit 11. For example, the usage request acquired by the generation unit 12 in step S1 may include user information (e.g., account information) for identifying the user. In this case, the determination unit 13 may acquire the list information corresponding to the user indicated by the user information by referring to the storage unit 11 using the user information as key information.

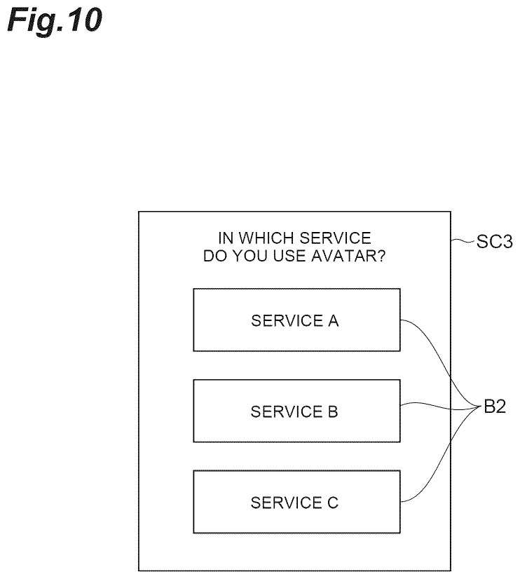

In step S22, the determination unit 13 allows the user to specify one of the services included in the list information. As an example, the determination unit 13 displays the service selection screen SC3 shown in FIG. 10 on the display unit 20a of the user terminal 20 and allows the user to select one of the services.

In step S23, the determination unit 13 determines the service specified by the user as the target service. For example, as shown in FIG. 10, the determination unit 13 arranges selection buttons B2 corresponding to each of the services included in the list information (here, as an example, Services A, B, C) on the service selection screen SC3. In this case, the determination unit 13 may determine the service corresponding to the selection button B2 selected by the user as the target service.

### Third Example

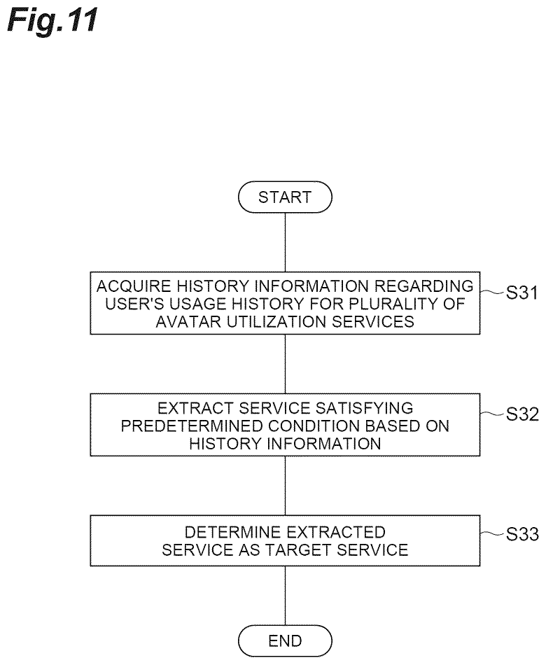

FIG. 11 is a flowchart showing a third example of the processing in step S2. The third example corresponds to the second pattern described above. In the third example, the determination unit 13 determines the target service based on the history information stored in the storage unit 11. FIG. 12 is a diagram showing an example of the history information. An example of the operation related to the above processing will be described below.

In step S31, the determination unit 13 acquires the history information (see FIG. 12) regarding the user's usage history for the plurality of avatar utilization services from the storage unit 11. For example, the usage request acquired by the generation unit 12 in step S1 may include user information (e.g., account information) for identifying the user. In this case, the determination unit 13 may acquire the history information corresponding to the user indicated by the user information by referring to the storage unit 11 using the user information as key information.

In step S32, the determination unit 13 extracts the service satisfying a predetermined condition based on the history information. In the example of FIG. 12, for example, if the current time is “00:00 on Aug. 1, 2022” and the predetermined condition is “the service most recently used by the user,” Service C is extracted. If the predetermined condition is “the service with the highest number of uses in the recent predetermined period (e.g., 5 days),” Service A with the highest total number of uses (login times) is extracted. If the predetermined condition is “the service used for the longest time in the recent predetermined period (e.g., 5 days),” Service B with the longest total usage time is extracted.

In step S33, the determination unit 13 determines the service extracted in step S32 as the target service.

Returning to FIG. 7, in step S3, the parameter acquisition unit 14 acquires the drawing parameters indicating the drawing conditions applied to the avatar in the target service. As an example, the parameter acquisition unit 14 acquires the drawing parameters corresponding to the target service from the storage unit 11 by referring to the storage unit 11 using the target service as key information. If the target service is “Service A,” the drawing parameters Ra corresponding to Service A are acquired.

In step S4, the display unit 15 generates and displays the preview image using the acquired drawing parameters Ra. For example, as shown in FIG. 5, the display unit 15 generates and displays the preview screen SC2 including the preview image showing the avatar 50A with the drawing parameters Ra applied, instead of the avatar 50 with the drawing parameters R prepared in advance in the avatar generation environment.

In the avatar generation device 10 described above, the function to preview the generated avatar is provided to the user along with the avatar generation environment (object generation environment) for generating the avatar. Furthermore, during the preview display, the avatar displayed is not based on the drawing parameters R prepared in advance in the avatar generation environment but on the drawing parameters used in one of the avatar utilization services (target service) that provide the virtual space (e.g., the drawing parameters Ra of Service A as the target service) (see FIG. 5). According to the above configuration, the user can confirm the appearance applied when the avatar is used in the target service at the time of the preview display (i.e., before the user actually uses the avatar in the target service). As a result, when the user actually uses the avatar generated in the avatar generation environment in the target service, the appearance of the avatar can be prevented from deviating from the user's intention, thereby improving the quality of the user's service experience.

The avatar generation device 10 includes a storage unit 11 that stores the drawing parameters corresponding to each of the plurality of services in association with each of the plurality of services, and the parameter acquisition unit 14 acquires the drawing parameters corresponding to the target service from the storage unit 11 by referring to the storage unit 11 using the target service as key information. According to the above configuration, by storing the drawing parameters of each of the plurality of services in advance in the avatar generation device 10, the drawing parameters of the target service can be easily and immediately acquired. As a result, it is possible to immediately generate and display the preview image with the drawing parameters corresponding to the target service applied.

The avatar generation device 10 (mainly the determination unit 13) is configured to execute the processing of the first example described above (see FIG. 8). According to the above configuration, by determining the avatar utilization service from which the transition was made as the target service, it is possible to allow the user to confirm the appearance of the avatar displayed in the avatar utilization service that is highly likely to be used immediately after the avatar is generated in the avatar generation environment. Furthermore, since explicit specification operations from the user for determining the target service are not required, it is possible to reduce the user's effort in determining the target service.

The avatar generation device 10 (mainly the determination unit 13) is configured to execute the processing of the second example described above (see FIG. 9). According to the above configuration, by allowing the user to specify the target service, it is possible to reliably determine the service desired by the user as the target service. Furthermore, for example, by presenting the list of services usable by the user to the user and allowing the user to specify one of the services from the presented list, it is possible to improve the user's convenience in specifying (selecting) the target service.

The avatar generation device 10 (mainly the determination unit 13) is configured to execute the processing of the third example described above (see FIG. 11). According to the above configuration, it is possible to determine an appropriate target service (i.e., a service that the user is highly likely to want to confirm the appearance of the avatar during service use) based on the user's usage history for the plurality of services. Furthermore, similar to the first example, since explicit specification operations from the user for determining the target service are not required, it is possible to reduce the user's effort in determining the target service.

In the above embodiment, the avatar generation device 10 for generating avatars, which are an example of virtual objects, has been described, but the avatar generation device 10 described above may be configured as a device for generating virtual objects other than avatars. In this case, the same effects as those of the avatar generation device 10 described above can be obtained. That is, when the user actually uses the virtual object generated by the generation environment in the target service, the appearance of the virtual object can be prevented from deviating from the user's intention, thereby improving the quality of the user's service experience.

In the above embodiment, the avatar generation device 10 is configured as a device separate from the user terminal 20, but the avatar generation device 10 may be the same as the user terminal 20. That is, the functions of the avatar generation device 10 described above (see FIG. 4) may be incorporated into the user terminal 20. In other words, the user terminal 20 may function as the avatar generation device 10 described above. Alternatively, some of the functions of the avatar generation device 10 described above may be incorporated into the user terminal 20. For example, functions other than the storage unit 11 described above may be implemented in the user terminal 20. In this case, the determination unit 13 and the parameter acquisition unit 14 incorporated into the user terminal 20 are configured to access the storage unit 11 held by the avatar generation device 10 to acquire the necessary data. However, when providing the avatar generation environment to multiple users, it is preferable that the avatar generation device 10 is configured as a device separate from the user terminal 20 (i.e., a device capable of providing the avatar generation environment to each user terminal 20 of multiple users) as in the above embodiment.

The virtual object generation device (avatar generation device 10 in the above embodiment) of the present disclosure has the following configuration.
[1] A virtual object generation device including:
a generation unit configured to generate a virtual object usable in a plurality of services that provide a virtual space to a user;
a determination unit configured to determine a target service that is one of the plurality of services;
a parameter acquisition unit configured to acquire a drawing parameter indicating a drawing condition applied to the virtual object in the target service;
a display unit configured to generate and display a preview image showing the virtual object corresponding to the target service by applying the drawing parameter acquired by the parameter acquisition unit to the virtual object generated by the generation unit.
[2] The virtual object generation device according to [1], further including a parameter storage unit configured to store the drawing parameters corresponding to each of the plurality of services in association with each of the plurality of services,
wherein the parameter acquisition unit acquires the drawing parameter corresponding to the target service from the parameter storage unit by referring to the parameter storage unit using the target service as key information.
[3] The virtual object generation device according to [1] or [2],
wherein the generation unit provides an object generation environment to determine an appearance of the virtual object to the user based on operations by the user,
the determination unit acquires, when the object generation environment transitions from a first state to a second state where the user uses the object generation environment, service information indicating one of the plurality of services used by the user in the first state and determines the one of the plurality of services indicated by the service information as the target service.
[4] The virtual object generation device according to [1] or [2], further including a list information storage unit configured to store list information indicating a list of services usable by the user among the plurality of services,
wherein the determination unit allows the user to specify one of the services included in the list information stored in the list information storage unit, and determines the one of the services specified by the user as the target service.
[5] The virtual object generation device according to [1] or [2], further including a history information storage unit configured to store history information regarding usage history of the user for the plurality of services,
wherein the determination unit determines the target service based on the history information stored in the history information storage unit.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but not limited thereto.

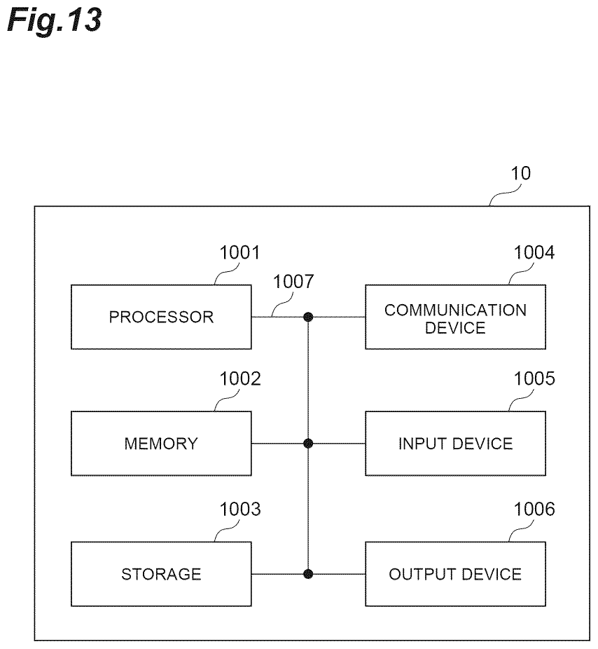

For example, the avatar generation device 10 according to an embodiment of the present invention may function as a computer that performs information processing method of the present disclosure. FIG. 13 is a diagram illustrating an example of a hardware configuration of the avatar generation device 10 according to the embodiment of the present disclosure. The avatar generation device 10 described above may be physically configured as a computer device including a processor 1001, a memory 1002, a storage 1003, a communication device 1004, an input device 1005, an output device 1006, a bus 1007, and the like. The user terminal 20 may also be equipped with the same hardware configuration as the avatar generation device 10.

In the following description, the term “device” can be referred to as a circuit, a device, a unit, or the like. The hardware configuration of the avatar generation device 10 may include one or a plurality of devices illustrated in FIG. 13, or may be configured without including some of the devices.

Each function in the avatar generation device 10 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, each functional unit (e.g., the display unit 15) of the avatar generation device 10 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the information processing method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different between the devices.

Further, the avatar generation device 10 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Although the present embodiment has been described in detail above, it is apparent to those skilled in the art that the present embodiment is not limited to the embodiments described in the present disclosure. The present embodiment can be implemented as a modification and change aspect without departing from the spirit and scope of the present invention determined by description of the claims. Accordingly, the description of the present disclosure is intended for the purpose of illustration and does not have any restrictive meaning with respect to the present embodiment.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called another name.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Further, the information, parameters, and the like described in the present disclosure may be expressed using an absolute value, may be expressed using a relative value from a predetermined value, or may be expressed using another corresponding information.

Names used for the above-described parameters are not limited names in any way. Further, equations or the like using these parameters may be different from those explicitly disclosed in the present disclosure. Since various information elements can be identified by any suitable names, the various names assigned to these various information elements are not limited names in any way.

The description “based on (on the basis of)” used in the present disclosure does not mean “based only on” unless otherwise noted. In other words, the description “based on” means both of “based only on” and “based at least on”.

Any reference to elements using designations such as “first,” “second,” or the like used in the present disclosure does not generally limit the quantity or order of those elements. These designations may be used in the present disclosure as a convenient way for distinguishing between two or more elements. Thus, the reference to the first and second elements does not mean that only two elements can be adopted there or that the first element has to precede the second element in some way.

When “include”, “including” and transformation of them are used in the present disclosure, these terms are intended to be comprehensive like the term “comprising”. Further, the term “or” used in the present disclosure is intended not to be exclusive OR.

In the present disclosure, for example, when articles such as “a”, “an”, and “the” in English are added by translation, the present disclosure may include that nouns following these articles are plural.

In the present disclosure, a sentence “A and B are different” may mean that “A and B are different from each other”. The sentence may mean that “each of A and B is different from C”. Terms such as “separate”, “coupled”, and the like may also be interpreted, similar to “different”.

### REFERENCE SIGNS LIST

10 Avatar generation device (virtual object generation device)
11 Storage unit (parameter storage unit, list information storage unit)
12 Generation unit
13 Determination unit
14 Parameter acquisition unit
15 Display unit
20 User terminal
30 Server
50, 50A Avatar (virtual object)
A, B, C Service
R, Ra Drawing parameter

1. A virtual object generation device comprising:
a generation unit configured to generate a virtual object usable in a plurality of services that provide a virtual space to a user;
a determination unit configured to determine a target service that is one of the plurality of services;
a parameter acquisition unit configured to acquire a drawing parameter indicating a drawing condition applied to the virtual object in the target service;
a display unit configured to generate and display a preview image showing the virtual object corresponding to the target service by applying the drawing parameter acquired by the parameter acquisition unit to the virtual object generated by the generation unit.

2. The virtual object generation device according to claim 1, further comprising a parameter storage unit configured to store the drawing parameters corresponding to each of the plurality of services in association with each of the plurality of services,
wherein the parameter acquisition unit acquires the drawing parameter corresponding to the target service from the parameter storage unit by referring to the parameter storage unit using the target service as key information.

3. The virtual object generation device according to claim 1,
wherein the generation unit provides an object generation environment to determine an appearance of the virtual object to the user based on operations by the user,
the determination unit acquires, when the object generation environment transitions from a first state to a second state where the user uses the object generation environment, service information indicating one of the plurality of services used by the user in the first state and determines the one of the plurality of services indicated by the service information as the target service.

4. The virtual object generation device according to claim 1, further comprising a list information storage unit configured to store list information indicating a list of services usable by the user among the plurality of services,
wherein the determination unit allows the user to specify one of the services included in the list information stored in the list information storage unit, and determines the one of the services specified by the user as the target service.

5. The virtual object generation device according to claim 1, further comprising a history information storage unit configured to store history information regarding usage history of the user for the plurality of services,
wherein the determination unit determines the target service based on the history information stored in the history information storage unit.
